(19) United States
(12) Patent Application Publication
(10) Pub. No.: US 2007/0278280 A1
(43) Pub. Date: Dec. 6, 2007

(54) Mailing Device With Additional Hidden Pocket and Method of Use

(76) Inventors: Andrew Gordon Wert, Avon, CT (US); Margaret Johanna Wert, Avon, CT (US)

Correspondence Address: WHITE-WELKER & WELKER, LLC, P.O. BOX 199, CLEAR SPRING, MD, 21722-0199, US

(21) Appl. No.: 11/747,996

(22) Filed: Jun. 11, 2007

Related U.S. Application Data
(63) Continuation-in-part of application No. 11/443,944, filed on May 31, 2006.

(51) Int. Cl. B42D 15/08; B42D 15/00; B65D 27/12; B65D 27/14

(52) U.S. Cl. 229/80; 229/76; 229/92.8

(57) ABSTRACT

The mailing device of the present invention consists of a rectangular card having front and back surfaces. Front and back surfaces are divided and foldable into three corresponding sections; the front surface having first, second, and third sections; and the back surface having fourth, fifth and sixth sections. The device includes a window allowing dimensional contents to be viewed and supporting structure to resist crushing. A pocket feature allows money, notes, gift cards, etc. to be inserted by the consumer and mailed within the device. The pocket is hidden from view and located between the first section and fourth section of the mailing device. The pocket is closed by bending an envelope flap attached to the first section of the device over the fourth section of the mailing device. The envelope flap is further comprised of a low-tack adhesive strip providing securing means to the fourth section of the device.

### CROSS REFERENCE TO RELATED APPLICATIONS

This application is a continuation in part from U.S. patent application Ser. No. 11/443,944, entitled “Mailing Device and Method of Use”, filed on May 31, 2006, herein incorporated by reference.

This application is related to U.S. Provisional Patent Application Ser. No. 60/685,570, entitled “Post Card Mailer Box”, filed on May 31, 2005, herein incorporated by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to postcards. More specifically, the present invention relates to an educational postcard with display areas that is constructs of multiple panels that can securely display contents without a protruding surface.

### BACKGROUND OF THE INVENTION

The broad concept of post card mailers comprised of see through windows and content areas on the front and back external surfaces is well established in the prior art. See U.S. Pat. No. 3,266,714 filed in 1964. Many improvements to this simple device have occurred which include the use of adhesives (U.S. Pat. No. 4,807,807) and other embodiments for providing shipping and display means for photographs (U.S. Pat. No. 4,079,881 and U.S. Pat. No. 5,788,144).

The prior art noted herein suffers from many shortcomings. For example, the prior art does not teach use for providing additional surfaces in a multi-folding format for the inclusion of additional information on additional interior and exterior surfaces or sections.

More specifically, U.S. Pat. No. 3,266,714 teaches a postcard constructed for mailing photos and “similar” articles that are essentially so thin that they can be considered two-dimensional. It is therefore an objective of the present invention to teach a mailing device that provides for securing “dimensional” contents that are not flat.

U.S. Pat. No. 4,237,633 issued to Murrell in 1980 and now expired teaches a basic folding mailing postcard. This postcard provides for five segments that may contain themed content, messages, mailing addressed, and a window for viewing content place on one segment that comprises and interior portion when folded flat. Murrell's device protrudes from the case, while the present invention eliminates all protrusions resulting in a flat mailer that is less likely to be destroyed or damaged in transit.

U.S. Pat. No. 6,024,278 issued to Martin, teaches and illustrates a multi-foldable, collapsible mailing article. Martin's mailing article suffers from many shortcoming since it provides for no advertising means or content, is not foldable or expandable to accommodate various sized content, and it for mailing collectibles only.

U.S. Pat. No. 6,189,774 issued to Pearson and U.S. Pat. No. 6,807,761 issued to Rappaport, et al. both disclosed a bi-mailing postcard for use as picture frames. Pearson incorporates a bi-panel design for securing the picture within the postcard and provides for a window and a slot while Rappaport, et al. uses a multi-layer composition and side-loading slot. Both incorporate a triangular shaped element for supporting the postcard in an upright position. While both teach the folding and window elements of the present invention, neither disclose a tri-panel, or multi-fold design as utilized by the present invention.

Japanese Patent Application No. 2003-096567 filed on Feb. 24, 2003, with corresponding Publication No. 2004-255860 by YAMAGUCHI KIYOSHI and KAMIJO DAIJI teaches a nonstandard-size post card which enables goods and/or articles to be held within an aperture portion space by providing a vicinity of a midsection with the aperture portion and enclosing the portion with attaching sheets such as plastics on both sides of the postcard. The vicinity of the midsection of the postcard is provided with the aperture portion and covered with sheets such as plastics on both the sides of the postcard, thereby the goods and/or articles can be held within the enclosed space. The present invention is distinguishable over this device for many reasons; the present invention does not have a protruding case, and the present invention has a flat writing surface covering the external back side of the mailer.

One shortcoming of the mailing devices of the prior art is that they are designed only to secure contents that are flat or dimensionless. The mailing devices of the prior art can not accommodate contents which are dimensional, having some thickness, width, and height, that must requires more than a flat postcard mailer with a minimal thickness, essentially eliminating a dimension.

Another shortcoming of the mailing devices of the prior art is that to accommodate dimensional contents they must often have protruding display areas which may result in damage during shipment when these irregular shaped mailers are sorted or packaged for transport.

Yet another shortcoming is that they have no provision for supporting structures that can prevent the mailer itself and its contents from being crushed.

### SUMMARY OF THE INVENTION

The present invention is a multi-paneled postcard constructed such that it can securely display dimensional contents without a protruding display area. Construction of the multi-paneled postcard includes supporting structures to prevent the mailing device from being crushed when mailed. It is intended that a user would purchase the postcard pre-packaged with dimensional contents such as collectibles, magnets, trading cards, stickers, games, electronics, CD/DVDs or other pre-recorded media and write a personalized message on the mailing device before mailing it to a recipient.

In an alternative embodiment a user can purchase the pre-constructed postcard taught by the present invention, add their own dimensional content, seal, and write a personal note on the device before mailing to the recipient.

The mailing device of the present invention consists of a rectangular card having front and back surfaces. The front and back surfaces are divided into three corresponding sections; the front surface having a first, second, and third sections; and the back surface having fourth, fifth and sixth sections. The first section corresponds to the fourth section; the second section corresponds to the fifth section and the said third section corresponds to the sixth section. The sections are defined by flexible spines as means for folding the sections together into a flat orientation and, when folded, the front surfaces define the interior of the folded mailer and the back surfaces define the exterior of the mailer.

The first section contains mailer contents while the second section defines an interior center. The third section defines an interior side and contains information while the fourth section defines an exterior back surface when folded providing an area for postage and messages. The fifth section which the exterior center and front when folded; and the sixth section defines an interior surface when folded and contains information.

A pocket feature allows money, notes, gift cards, etc. to be inserted by the consumer and mailed within the mailing device. The pocket is hidden from view and located between the first section and fourth section of the mailing device. The pocket is closed or sealed by bending an envelope flap attached to the first section of the mailing device over the fourth section of the mailing device. The envelope flap is further comprised of a low-tack adhesive strip that provides securing means to the fourth section of the mailing device.

It is an objective of the present invention to teach a mailing device consisting of supporting structures that can prevent the mailer itself and its contents from being crushed.

It is therefore another objective of the present invention to teach a mailing device that provides for securing “dimensional” contents that are not flat.

In addition, it is another objective of the present invention to teach a mailing device that does not require protruding areas which securing dimensional contents.

It is also an objective of the present invention to teach a mailing device that is foldable and/or expandable to accommodate various sized content.

It is another objective of the present invention to teach a mailing device with means for sending content, internal messages, and external message such as advertising.

It is yet another objective of the present invention to teach a mailing device with means for providing a hidden pocket for securely and discreetly sending small items of value such as money or gift cards.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a planar view of the interior sections of a tri-panel embodiment of the mailing device of the present invention;

FIG. 2 is a planar view of the exterior sections of a tri-panel embodiment of the mailing device of the present invention;

FIG. 3 is a perspective view of a tri-panel embodiment of the partially folded mailing device of the present invention;

FIG. 4 is a planar view of the interior sections of a tri-panel embodiment of the mailing device of the present invention;

FIG. 5 is a planar view of the exterior sections of a tri-panel embodiment of the mailing device of the present invention;

FIG. 6 is a perspective view of the exterior sections of a bi-panel embodiment of the mailing device of the present invention

FIG. 7 is a planar view of the interior sections of a tri-panel alternative embodiment of the mailing device of the present invention with a hidden pocket; and

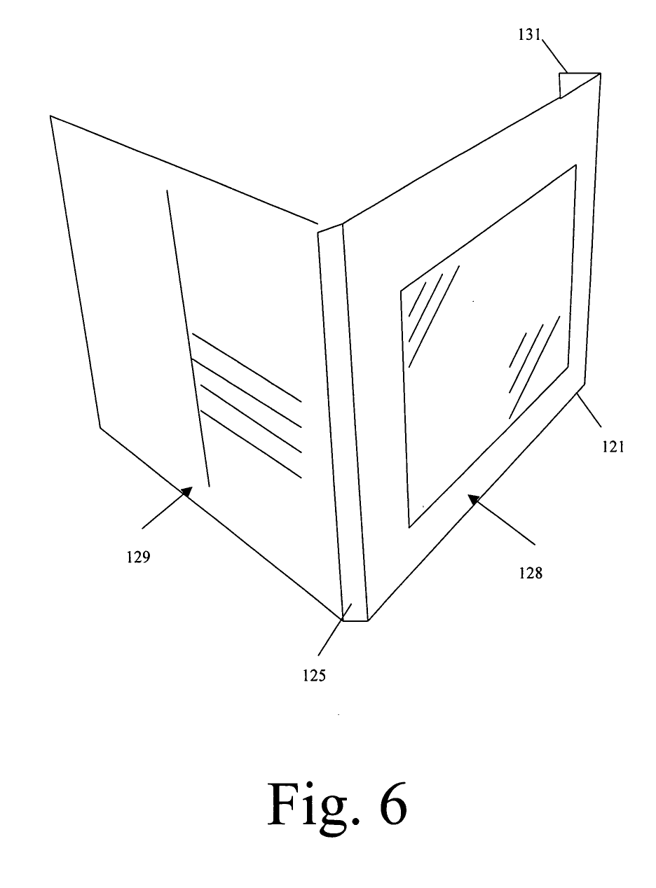

FIG. 6 is a planar view of the exterior sections of a tri-panel alternative embodiment of the mailing device of the present invention with a hidden pocket.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a mailing device.

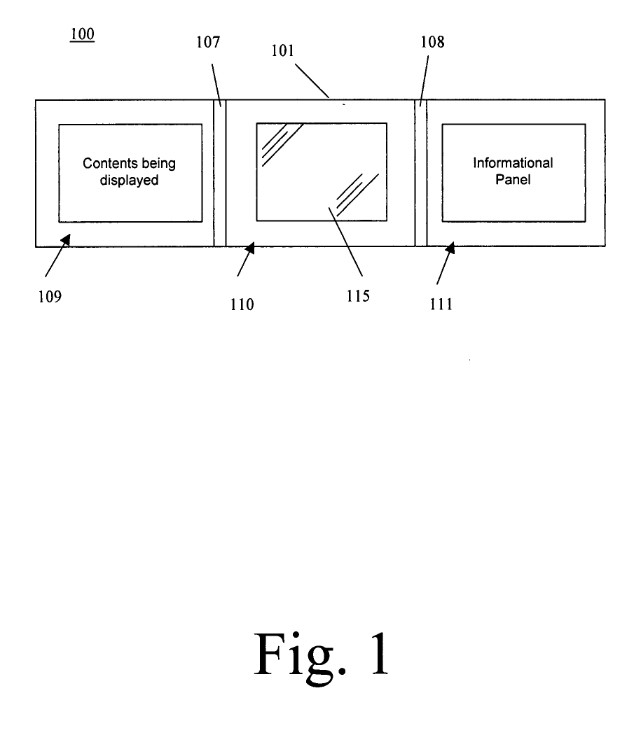

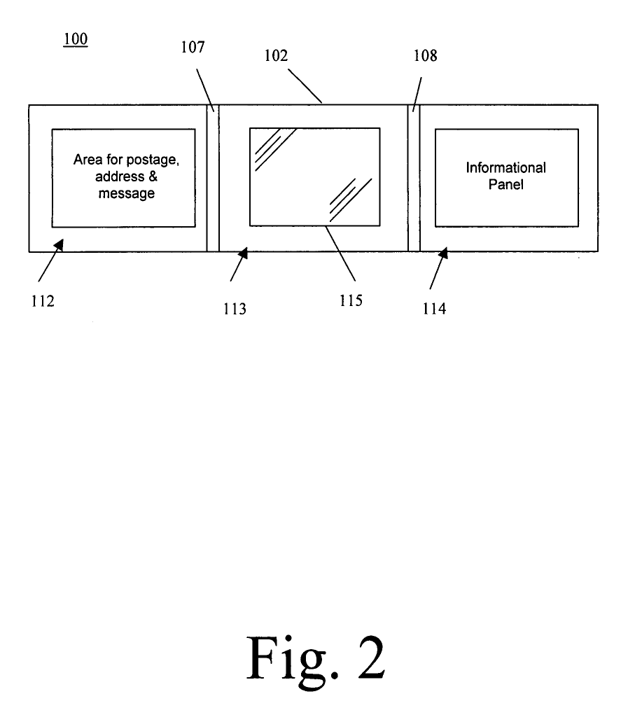

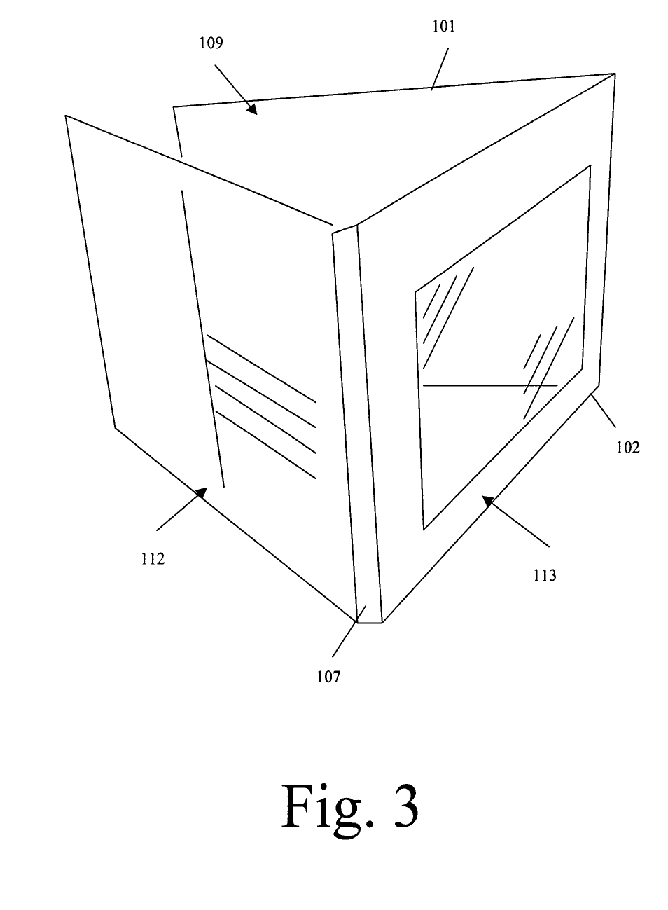

Now referring to FIGS. 1-3, a preferred embodiment of the mailing device is disclosed. The mailing device of the present is comprised of a rectangular card 100 having a front surface 101 and a back surface 102. The front surface 101 and the back surface 102 are each divided into three corresponding sections which can be folded about two lines 107 and 108.

The front surface 101 is comprised of first 109, second 110, and third 111 sections while the back surface 102 is further comprised of fourth 112, fifth 113, and sixth 114 sections. The first section 109 of the front surface 101 corresponds to the fourth section 112 of the back surface 102; the second section 110 of the front surface 101 corresponds to the fifth section 113 of the back surface 102; and the third section 111 of the front surface 101 corresponds to the sixth section 114 of the back surface 102.

The sections are defined by and can be folded about two lines 107 and 108. Flexible spines may be used as means for folding the sections together about two lines 107 and 108 into a flat orientation. When folded, the front surface 102 defines the interior of the folded mailer while the fourth 112 and sixth 114 sections of the back surface 102 define the exterior of the mailer.

With respect to content, the said first section 109 contains internal mailer contents that can be displayed through a window. The second section 110 defines an interior center that may contain a window 115 that allows viewing of the contents on the first section 109, when the mailer is folded closed. The third section 111 defines an interior side and contains information as desired. The fourth section 112 defines an exterior back surface when the mailing device is folded, providing an area for postage and messages. The fifth section 113 defines the exterior center and front when folded. The fifth section 113 may also contain a window 115 that allows viewing of the contents on the first section 109, when the mailer is folded closed. The sixth section 114 defines an interior surface when folded that contains information.

In one embodiment the mailing device is similar to that of a standard post card having a folded or closed dimension of approximately 6 inches high, 8 inches wide, and ⅜ inches deep. When open or unfolded, the mailing device is approximately 6 inches high, 24¾ inches wide, and 1/32 inch deep. When closed or folded, each section lies flat on or below another section. Additionally, to avoid shipping damage, all exterior corners are square and the window 115 is flush. The mailing device 100 and window 115 can be made from any material suitable for mailing that is sturdy enough to withstand multiple mailings through the U.S. Postal System.

The first section 109 defines the interior left panel when the mailing device is folded. The first section 109 should contain mailer contents that would be visible through the window 115 on the front of the folded or closed mailer device. The first section 109 may also be further comprised of a tray or blister pack 116 for securing additional contents. The tray must be able to accommodate a card approximately 7.5×5.5 inches in size, but allow for slight modification on card, to scale, base on packaging requirements. The blister pack must accommodate a card approximately 7.5×5.5 inches in size, but allow for slight modification on card, to scale, base on packaging requirements. The blister bubble 116 should be slightly larger than the window 115 with an inner elevated ridge 117¾ inch from edges on all sides.

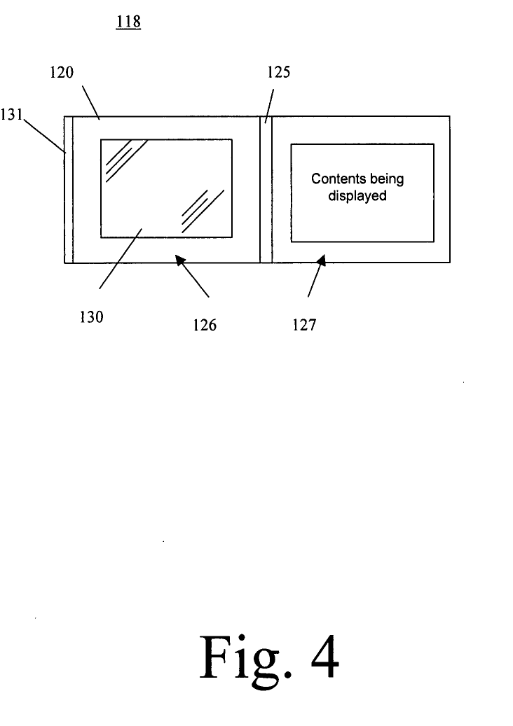

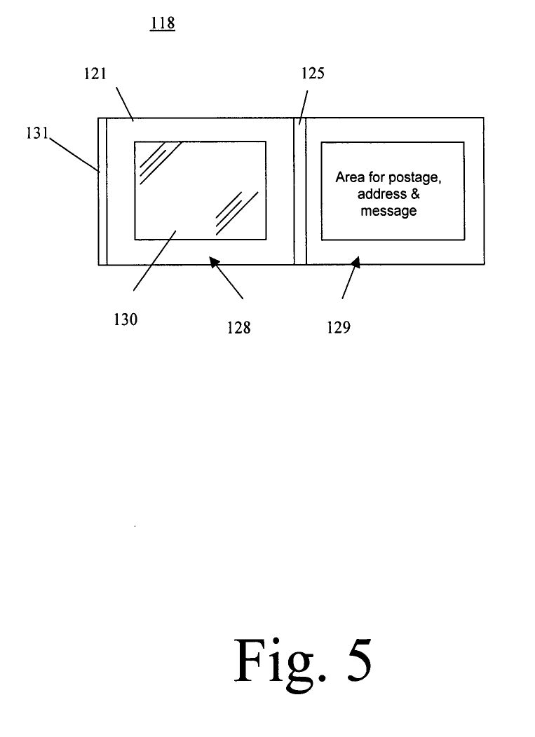

Now referring to FIGS. 4-6, an alternative bi-panel mailing device 118 of the present invention is shown. The bi-panel mailing device 118 of the present is comprised of a rectangular case 119 having a front surface 120 and a back surface 121. The front surface 120 and the back surface 121 are each divided into two corresponding sections that can be folded about one line 125.

The front surface 120 is further comprised of first 126 and second 127 sections while the back surface 121 is further comprised of third 128 and fourth 129 sections. The first section 126 of the front surface 120 corresponds to the third section 128 of the back surface 121; the second section 127 of the front surface 120 corresponds to the fourth section 129 of the back surface 121.

The sections are defined by and can be folded about one line 125. Hinges or other similar rotating means known in the prior art may be used as means for folding the sections together about the line 125 into a flat orientation. When folded, the front surface 120 defines the interior of the folded mailer while the back surface 121 define the exterior of the mailer. Corresponding sections 128 and 126 are further comprised of an additional closing flap 131 that seals off the edge of the mailing device and is retained by separate securing means such as a sticker. The closing flap 131 is folded over the exposed edge and onto the back exterior surface 129 where it is then secured.

With respect to content, the second section 127 contains internal mailer contents that can be displayed through a window 130. The first section 126 defines an interior center that may contain a window 115 that allows viewing of the contents on the second section 127, when the mailer is folded closed. The third section 128 defines an exterior side that may also contain a window 126 that allows viewing of the contents on the second section 127, when the mailer is folded closed. The fourth section 129 defines an exterior back surface when the mailing device is folded, providing an area for postage and messages.

In one embodiment the bi-panel mailing device is similar to that of a standard CD jewel case. When closed or folded, each section lies flat on or below another section. The bi-panel mailing device 118 and window 126 can be made from any material suitable for mailing that is sturdy enough to withstand multiple mailings through the U.S. Postal System. Typically, a CD jewel case is made from a paper product or plastic, both of which would be suitable for the application of the present invention.

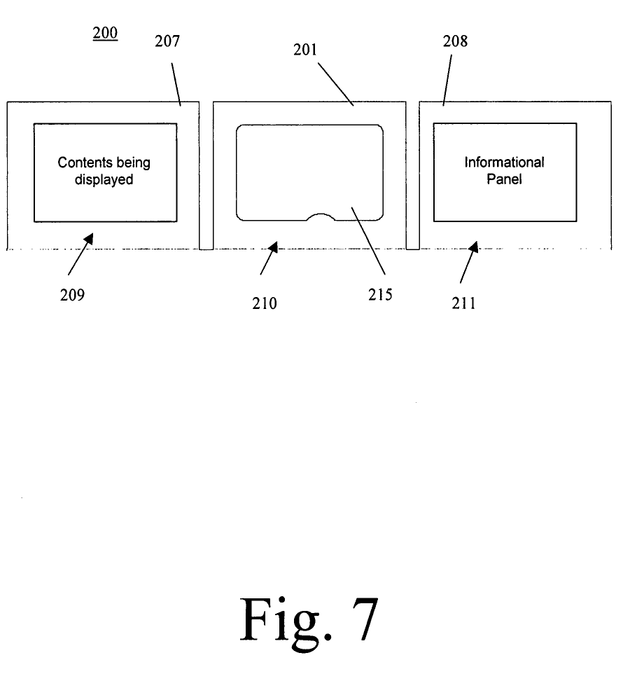

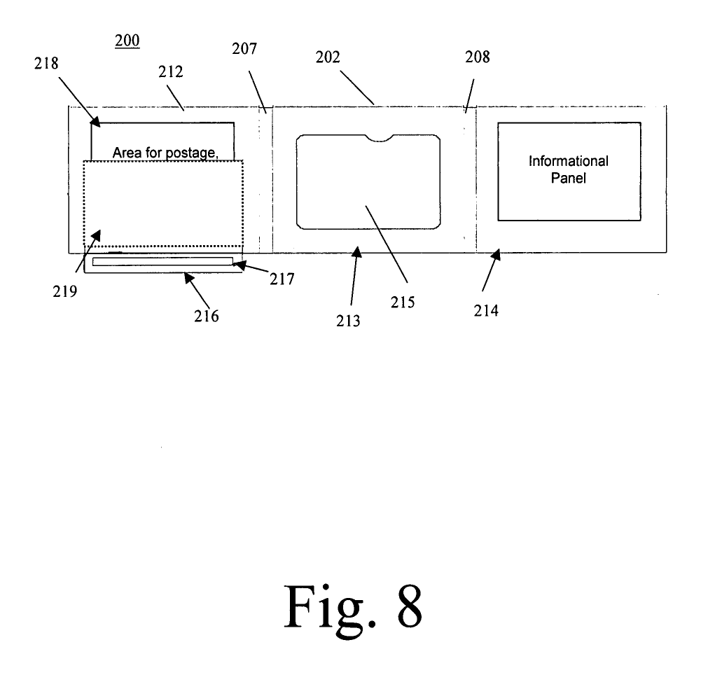

In another alternative embodiment, the present invention in both its bi-panel and tri-panel forms is further comprised of a pocket 219 enhancement feature. Now referring to FIGS. 7-8, a preferred embodiment of the mailing device is disclosed. The mailing device of the present is comprised of a rectangular card 200 having a front surface 201 and a back surface 202. The front surface 201 and the back surface 202 are each divided into three corresponding sections that can be folded about two lines 207 and 208.

The front surface 201 is comprised of first 209, second 210, and third 211 sections while the back surface 202 is further comprised of fourth 212, fifth 213, and sixth 214 sections. The first section 209 of the front surface 201 corresponds to the fourth section 212 of the back surface 202 which provides an area for postage, address, and message 218; the second section 210 of the front surface 201 corresponds to the fifth section 213 of the back surface 202; and the third section 211 of the front surface 201 corresponds to the sixth section 214 of the back surface 202.

The sections are defined by and can be folded about two lines 207 and 208. Flexible spines may be used as means for folding the sections together about two lines 207 and 208 into a flat orientation. When folded, the front surface 202 defines the interior of the folded mailer while the fourth 212 and sixth 214 sections of the back surface 202 define the exterior of the mailer. The second section 210 defines an interior center that may contain a window 215 that allows viewing of the contents on the first section 209, when the mailer is folded closed.

A pocket 219 feature allows money, notes, gift cards, etc. to be inserted by the consumer and mailed within the mailing device. The pocket 219 is hidden from view and located between the first section 209 and fourth section 212 of the mailing device 200. The pocket 219 is closed or sealed by bending an envelope flap 216 attached to the first section 209 of the mailing device 200 over the fourth section 212 of the mailing device 200. The envelope flap 216 is further comprised of a low-tack adhesive strip 217 that provides securing means to the fourth section 212 of the mailing device 200.

In use a consumer first peels open the envelope flap 216 and inserts money, notes, gift cards, etc into the pocket 219. In a second step, a paper strip covering the low-tack adhesive strip 217 is removed, exposing high-tack adhesive. In a third step the envelope flap 216 with the exposed low-tack adhesive strip 217 is secured to the fourth section 212 of the mailing device 200 and the mailing device is ready to be mailed.

One of ordinary skill in the art will appreciate that the tri-panel mailing device 200 illustrated in FIGS. 7-8 can easily and quickly be made or converted into a bi-panel mailing device by either removing or eliminating in the manufacturing process one additional panel as illustrated in the tri-panel and bi-panel embodiments illustrated in FIGS. 1-6.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A mailing device comprising:
a rectangular card having a front surface and a back surface;
said front surface and a back surface are divided into three corresponding sections;
said front surface having first, second, and third sections;
said back surface having fourth, fifth and sixth sections;
said first section corresponds to said fourth section;
said second section corresponds to said fifth section; and
said third section corresponds to said sixth section;
a pocket located between any two corresponding sections; and
an envelope flap attached to said front surface section of the corresponding sections
said envelope flap further comprised of means for securing said envelope flap from said front surface section of the corresponding sections to the corresponding back surface section of the mailing device; and
said pocket sealed by bending said envelope flap attached to front surface section of the corresponding sections of the mailing device over a pocket opening and onto said corresponding sections to the corresponding back surface section of the mailing device.

2. The mailing device of claim 1 wherein
said pocket is located between said first section and fourth section; and
said envelope flap is attached to said first section
said envelope flap further comprised of means for securing said flap to the fourth section of the mailing device; and
said pocket sealed by bending said envelope flap attached to said first section of the mailing device over a pocket opening and onto said fourth section of the mailing device;

3. The mailing device of claim 1 wherein said sections are defined by flexible spines as means for folding the sections together into a flat orientation and when folded, said front surfaces define the interior of the folded mailer and said back surfaces define the exterior of the mailer.

4. The mailing device of claim 3 wherein said first section contains mailer contents;
said second section with defines an interior center;
said third section that defines an interior side and contains information;
said fourth section that defines an exterior back surface when folded providing an area for postage and messages;
said fifth section which defines the exterior center and front when folded; and
said sixth section that defines an interior surface when folded and contains information.

5. The mailing device of claim 4 wherein said second section and said fifth section are further comprised of a window which enables the viewing of content provided on the first section when the mailing device is in a folded position.

6. The mailing device of claim 4 wherein said first section further comprises a tray
providing means for attaching additional content, and
providing means for structural strength so that the mailing device can not be crushed during mailing.

7. The mailing device of claim 4 wherein said first section further comprises a blister pack for attaching additional content.

8. The mailing device of claim 1 wherein said envelope flap is further comprised of a low-tack adhesive strip that provides securing means to the fourth section of the mailing device.

9. A mailing device comprising:
a rectangular card having a front surface and a back surface;
said front surface and a back surface are divided into two corresponding sections;
said front surface having first, and second sections;
said back surface having third and fourth sections;
said first section corresponds to said third section;
said second section corresponds to said fourth;
said front surface is further comprised of an additional closing flap that seals off the edge of the mailing device and is retained by separate securing;
said closing flap is folded over the exposed edge and onto a back exterior surface where it is then secured;
a pocket located between any two corresponding sections; and
an envelope flap attached to said front surface section of the corresponding sections
said envelope flap further comprised of means for securing said envelope flap from said front surface section of the corresponding sections to the corresponding back surface section of the mailing device; and
said pocket sealed by bending said envelope flap attached to front surface section of the corresponding sections of the mailing device over a pocket opening and onto said corresponding sections to the corresponding back surface section of the mailing device.

10. The mailing device of claim 9 wherein
said pocket is located between said corresponding first section and fourth section; and
an envelope flap attached to said first section;
said envelope flap further comprised of means for securing said flap to the fourth section of the mailing device; and
said pocket sealed by bending said envelope flap attached to said first section of the mailing device over a pocket opening and onto said fourth section of the mailing device;

11. The mailing device of claim 9 wherein said sections are attached by a rotating means for folding the sections together into a flat orientation and when folded, said front surfaces define the interior of the folded mailer and said back surfaces define the exterior of the mailer.

12. The mailing device of claim 11 wherein
said first section defines an interior surface and contains information;
said second section defines an interior surface and contains information;
said third section that defines an exterior side and contains information; and
said fourth section that defines an exterior back surface when folded providing an area for postage and messages.

13. The mailing device of claim 12 wherein said second section and said third sections are further comprised of a window which enables the viewing of content provided on the first section when the mailing device is in a folded position.

14. The mailing device of claim 9 wherein said envelope flap is further comprised of a low-tack adhesive strip that provides securing means to the fourth section of the mailing device.
